(19) United States
(12) Patent Application Publication
(10) Pub. No.: US 2004/0193319 A1
(43) Pub. Date: Sep. 30, 2004

(54) Method of and apparatus for controlling driving of a gripping device to a movable piece material

(76) Inventors: Karl Josef Gross, Erbach (DE); Gerhard Duerr, Hoechst (DE); Ralf Schaller, Reichelsheim (DE)

Correspondence Address: STRIKER, STRIKER & STENBY, 103 East Neck Road, Huntington, NY, 11743, US

(21) Appl. No.: 10/755,140

(22) Filed: Jan. 9, 2004

(30) Foreign Application Priority Data
Jan. 10, 2003 (DE) 103 00 606.0

(51) Int. Cl. G06F 19/00

(52) U.S. Cl. 700/245; 700/213

(57) ABSTRACT

A method of driving on a movable piece material over a drive-on path, comprising the steps of providing a drive-on position of the piece material inside a drive-on region, computing control data sets preliminarily in a first computation step, providing in the control data set a travel set which describes the drive-on path at the drive-on position, starting the first computation step for the travel set from a fixed drive-on position of the piece material, optimizing the travel set to the first fixed position of the piece material with respect to the drive-on speed, determining, directly before a start of a drive-on movement in accordance with the travel set, an actual drive-on position of the piece material, performing a second computation step which a corresponding actual travel set changed depending on the determined actual drive-on position of the piece material so that the drive-on path is changed in direction of the actual drive-on position, and performing a drive-on movement by working off of the travel set determined in the second computation step.

### BACKGROUND OF THE INVENTION

The present invention relates to a method of driving of a gripping device to a movable piece material, and to a control apparatus for controlling its movement.

Gripping of piece material movable on a conveyor band with a gripping device, such a robot arm or the like, is a frequent step in manufacturing processes. Such a gripping device is controlled by a control apparatus, which timely optimizes the driving-on path through a point-to-point (PTP) interpolation, or in other words the driving-on path is designed for the fastest possible driving onto the piece material. The computation of a control data set which provides the movement of the gripping device is performed in real time, or in other words directly before the start of the driving-on movement or during the driving-on movement. When a control data set is worked off, or in other words the robot arm has reached the controlled piece material, in the real time the next control data set can be calculated, which for example can include other informations, such as the output of signals for monitoring, the control of receiving and discharging step of the piece material, and the like. The computation of these steps requires computing time and can interrupt the receiving steps of the gripping device, so that its movements are jerky.

Since as a rule the piece material is placed chaotically on the conveyor band, it is therefore not possible to determine before the driving-on of the piece material or possible to determine with considerable time expenses, how long the driving-on movement continues and at what location the driving-on position of the driving-on piece material is located. Because of these reasons, a preliminary computation of such a driving-on movement can not be performed in an optimal way, so that the piece material can not be driven-on with speed-and movement-optimal band synchronization.

### SUMMARY OF THE INVENTION

Accordingly, it is an object of the present invention to provide driving to a piece material which is movable on a conveyor band, in time optimal manner.

In keeping with these objects and with others which will become apparent hereinafter, one feature of the present invention resides, briefly stated in a method of driving on a movable piece material over a drive-on path, comprising the steps of providing a drive-on position of the piece material inside a drive-on region; computing control data sets preliminarily in a first computation step; providing in the control data set a travel set which describes the drive-on path at the drive-on position; starting the first computation step for the travel set from a fixed drive-on position of the piece material; optimizing the travel set to the first fixed position of the piece material with respect to the drive-on speed; determining, directly before a start of a drive-on movement in accordance with the travel set, an actual drive-on position of the piece material; performing a second computation step which a corresponding actual travel set changed depending on the determined actual drive-on position of the piece material so that the drive-on path is changed in direction of the actual drive-on position; and performing a drive-on movement by working off of the travel set determined in the second computation step.

Another feature of the present invention resides, briefly stated, in a control device for controlling a drive-on movement of a drive-on control apparatus of a drive-on device for removable piece material in which a drive-on position is driveable-on within a drive-on region in accordance with a travel set, the control apparatus comprising a first computing means for preliminarily computing control data sets in a first computation step, wherein the control data sets include at least one travel set computed based on a fixed drive-on position of the piece material in advance, and wherein the travel set describes a drive-on path, wherein the computed travel set is optimized for fixed position of the piece material with respect to a drive-on speed; a detector system for detecting an actual position of the piece material; a second computing means for performing directly before a start of the drive-on movement a further computation for the travel set in a second computation step, wherein the actual travel set is changed and depending on the determined actual position of the piece material so that the drive-on path is changed in direction of the drive-on position; and the control element for controlling a drive-on movement by discharging the travel set changed in the second computation step.

In accordance with a first aspect of the present invention, a method is proposed for driving on a movable piece material over a drive-on path. The piece material has a drive-on position which is located within a drive-on region. In a first computation step, control data set is calculated. The control data sets serve for a total control of the drive-on movements, for example a robot arm, as well as other such functions which are necessary for monitoring the operation functions or the like. For the drive-on movement, the control data set has a travel set which describes the drive-on path to a drive-on position. In the first computation step the computation of the travel set starts from a fixed drive-on position of the piece material. The travel set for fixed drive-on position of the piece material is optimized with respect to the drive-on speed. Immediately before the start of the drive-on movement in accordance with the travel set, the actual drive-on position of the piece material is determined and a second computation step is performed, in which the actual travel set is changed depending on the determined actual drive-on position so that the drive-on path is changed in direction of the actual drive-on position. The drive-on movement is then performed by driving off of the travel set determined in the second computation step.

In the inventive method the control data sets are computed preliminarily, so that during working off they are available and the computation time can be saved immediately before the working off of the corresponding step. During the preliminary computation of the travel sets, which provide a drive-on movement on a piece material, it is however not possible to preliminarily determine the position in which the piece material is located at the end of the preliminarily computed drive-on movement. Thereby the preliminary computation of the travel sets for drive-on movements is not optimal.

For these reasons it is provided that before performing a drive-on movement in accordance with the travel set, a new computation of the travel set in accordance with the actual determined drive-on position of the piece material is performed. With the aid of the new computed travel set, the piece material can be driven on. Since the control data set for the steps which take place after this travel step were computed in advance, then after reaching of the corresponding drive-on position for the piece material, directly the next control data set can be worked off without a computation or a determination of the corresponding following control data set. Thereby time is saved, so that the control data set, such as for example the travel sets or data sets can be performed with respect to receiving or discharging steps of the piece material substantially immediately one after the other.

Preferably it is provided that the control data sets of the first travel set for the first drive-on position and a second travel set for a second drive-on position are obtained, which can be preliminarily calculated with the aid of the first computation step, wherein the first and the second travel sets include path pieces which reproduce a drive-on path to first and second drive-on positions. Before reaching an end position of the first travel set, at least one first back piece of the second travel set is taken into consideration to guarantee a jerk-free transition of the drive-on movement from the first travel set to the second travel set. In this way a so-called overslipping of the travel movements can be performed, wherein during the travel movement to the first drive-on position already the second travel set is taken into consideration, so that smallest possible accelerations act on the gripping device and the drive-on movements are performed in a jerk-free and speed-optimum manner. This so-called overslipping can be also performed with travel sets which were calculated by the first computation step. The deviation produced from the inaccurate computation of the position of the piece material can be neglectable for the computation of the overslipping so that the preliminary computations of the travel sets made available in the inventive method make the movement of the gripping device gentler since high accelerations are avoided on the one hand, and since the control data sets are computed preliminarily and the control data sets are worked off in immediate sequence one after the other on the other hand.

Preferably, it is provided that in the second computation step the respective actually driven path piece is changed depending on the detected actual drive-on position of the piece material, in that the end point of the path piece is displaced by an angle which is dependent on the actual drive-on position of the piece material. In this manner it is possible to use substantially for a further computation the path piece of the travel set determined in the first computation step, wherein the path pieces of the travel sets are however corrected by a path which is dependent on the actual drive-on position of the piece material. It is therefore possible to shorten the computation of the travel set in the second computation step relative to the first computation of the first travel set, so that less time is required for the computation of the travel set in the second computation step.

It can be also provided that during the second computation step the corresponding actual driven path is changed depending on the movement speed of the piece material, by taking into consideration the speed of the path piece over the total travel set, so that a jerk-free drive-on and braking of the drive-on movement is possible. This has the advantage that during computation of the travel set for the actual drive-on position, the movement of the taken piece material can be taken into consideration, so that at a time point of the taking, the gripping device is moved with the taken piece material.

In order to allow a jerk-free drive-on movement, it is provided that the speed of the piece material is taken into consideration sine-square over the total travel set, so that in a drive-on region and in an end region, a smaller speed of the piece material in the second computation step is taken into consideration.

It is for example provided that with several travel sets which are preliminary computed with the aid of the first computation step, the travel set for a moving piece material is not converted into a drive-on movement when in the second computation step it is determined that the drive-on movement of the corresponding moving piece material has not reached within the drive-on region in a proper time. In this manner the start of a drive-on movement is avoided, when it is recognized before the start of the drive-on that the moving piece material can no longer reach inside the drive-on region. In this way time can be spared which must be used for a futile search that the piece material is taken. For definition of the drive-on region a second position of the corresponding piece material can be defined, wherein the travel set in the second computation step is not computed when the corresponding piece material is located in the movement direction behind the second position.

In accordance with a further aspect of the invention, a control device for controlling a drive-on movement of a drive-on device for movable piece material is provided. The drive-on position, or in other words the targeted position of the drive-on movement is drivable within a drive-on region in accordance with a travel set. The control device has a first computing means for preliminarily computing control data sets in a first computing step. The control data sets include at least one travel set which, starting from first drive-on position of the piece material is computed preliminarily. The travel set describes the drive-on path, wherein the computed travel set for the fixed drive-on position of the piece material is optimized with respect to the drive-on speed. The control device also has a detector system, for detecting the actual position of the piece material in the drive-on region. In a second computing means, directly before the start of the drive-on movement, a further computation for the travel set in a second computation step is performed, in which the actual travel set is changed depending on the detected actual position of the piece material, so that the drive-on path is corrected in direction of the drive-on position. With the aid of a control element, the drive-on movement is controlled by driving off of the travel set corrected in the second computing step.

In this way, a controlled apparatus can be provided for performing the inventive method. With the aid of the first and second computing means it is possible to compute travel sets or controlled data sets. By the preliminary computation of the control data sets the time for performing a travel can be reduced, since the time expense of a computation directly before the corresponding step of the corresponding control data set or of the travel set is smaller.

Preferably, the first and/or second computing means are designed so that during transition from the first travel set to a second travel set path pieces of the first travel set with path pieces of the second travel set are computed with one another, so that a substantially jerk-free transition from the movement of the first travel set to the movement of the second travel set is provided. This method of the so-called overslipping allows a jerk-free movement of the processing device on the one hand and reduces the time required for drive-on of the drive-on positions.

The novel features which are considered as characteristic for the present invention are set forth in particular in the appended claims. the invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a processing device for gripping of a piece material movable on a conveyor band, in accordance with the present invention;

FIG. 2 is a view showing a drive-on region of the processing device in accordance with the present invention; and

FIGS. 3a and 3b are flow diagrams for illustration of the method in accordance with the present invention.

### DESCRIPTION OF THE PREFERRED EMBODIMENTS

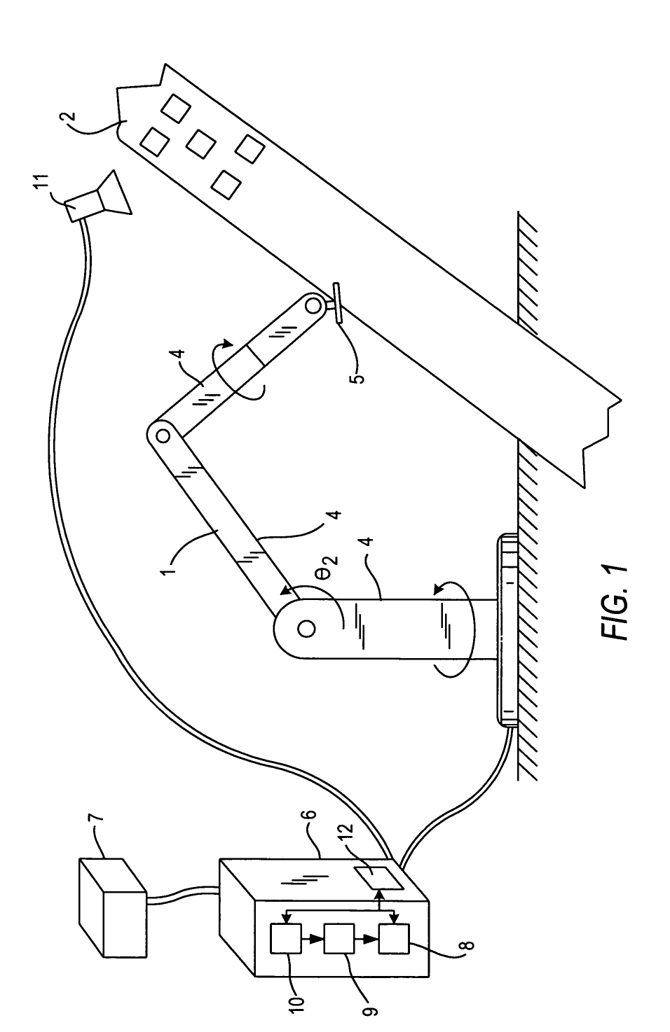

FIG. 1 is a view showing a robot system for picking up a piece material 3 which moves on a movable conveyor band 2 and is arranged in an arbitrary fashion. The robot system has a robot arm 1 with a plurality of turnable and/or rotatable arms 4. The arms 4 are connected with one another so that a gripper element 5 on one end of the robot arm 1 within a drive-on region can drive on each arbitrary position.

The gripping element 5 is designed so that a piece material 3 can be taken and held during a method movement. The gripping element 5 for this purpose can be designed as a gripping claw and/or a magnetic holding system. Also, other picking up systems are possible, such as for example a suction element, etc.

The robot arm 1 has the objective of taking the piece material 3 from the movable conveyor band 2 and, for example, transporting it to a palletizing position. In the palletizing position the piece material 3 is stacked and held for a further subsequent processing step. The movement of the robot arm 1 is controlled by a control element 12 in a control device 6. The control element 12 controls the movements of the robot arm 1 in accordance with available control data, so that the robot arm 1 can drive over a drive-on position provided by the control element 12. For driving the robot arm 1 on the drive-on position as fast as possible, the drive path is optimized in accordance with the PTP interpolation (point-to-point interpolation) with the PTP interpolation, the drive-on path is subdivided into a plurality of path pieces, wherein they are optimized with respect to the drive-on speed. During optimization of the drive-on speed, the corresponding adjusting members of the arms 4 are controlled with maximum values, so that they are moved as fast as possible, or in other words with maximum possible accelerations to the predetermined positions. All participating axes are rigid at the end of their movement simultaneously. The movement is put on the weakest axis.

The adjusting variables which are applied on the robot arm 1 for moving the gripper element 5 from a start position to a drive-on position form a travel set. Prior to performing a method movement a control device 6 calculates the travel set and applies the corresponding adjusting variables on the robot arm 1 at defined time points, so that the method movement is performed.

For monitoring the function of the robot system, after the drive-on a position, signals from the control device are reproduced on a monitoring system 7. For this purpose in a control device 6 control data sets are generated, which can produced a signal output for outputting one or more monitoring signals after the drive-on of the piece material 3 on the monitoring unit 7.

For saving the time during the drive-on movement of the robot arm 1 it is provided that the control device has a first computing means for preliminarily computing the control data sets such as travel sets or signal output data, and storing the same in a storage unit 9. In a storage unit 9 travel sets are stored for the next drive-on movements of the robot arm 1, wherein between the travel sets further control data sets can be provided for performing for example signal outputs on the monitoring unit 7 for controlling and further computations. Between the travel steps further control data sets can be provided for controlling for example signal outputs on the monitoring unit 7 and performing further computations.

The control data sets stored in the storage unit 9 are now worked off one after the other, or in other words with the aid of a travel set a drive-on movement of the robot arm 1 is performed. After the drive-on position has been reached, in accordance with a further travel set a taking or a discharging step is performed and eventually in accordance with one or several control data sets signal outputting or the like is performed, before a subsequent drive-on movement of the robot arm 1 is controlled by the following travel set. With these preliminary computations it is possible to save computation time between individual steps, so that the robot arm 1 is moved substantially without waiting times.

Because of multiple influences on the robot arm 1 or since the position of the piece material is arbitrary, it is possible only with difficulties to determine in advance the time period for working off of one of the control data sets, in particular the travel set. For this reason with respect to the travel sets which provide the drive-on movement of the robot arm 1, it is not possible or possible with difficulties to exactly compute in advance the travel set with respect to an accurate drive-on position. For this reason, before the start of the drive-on movement to a drive-on position in accordance with the straight actual travel set, a further computation must be performed with the aid of a second computation means 10, which compute the corresponding travel set again with respect to the actual position of the piece material on the conveyor band 2.

The actual position of the piece material 3 on the conveyor band 2 is determined with the aid of a position recognizing system 11 which determines the exact absolute position of the piece material 3 on the conveyor band 2. With the aid of the second computing means 10 then the corresponding travel set is computed, so that the drive-on position of the robot arm 1 corresponds to the position of the drive-on piece material 3 at the time point, at which the gripping element 5 preliminarily reaches the drive-on position. Then the gripping element 5 of the robot arm 1 reaches the drive-on position exactly at the time point, at which the piece material 3 to be driven on comes to its drive-on position.

In order to accelerate the new computation of the actual travel set shortly before the start of the drive-on movement in accordance with the drive set, it is recommended to perform the computations of this travel set so definitely, that on the basis of the preliminarily computed travel set the computation of the travel set in the second computation set step be accelerated. For this purpose the computation of the travel set in the first computation step is performed with respect to a predetermined base position.

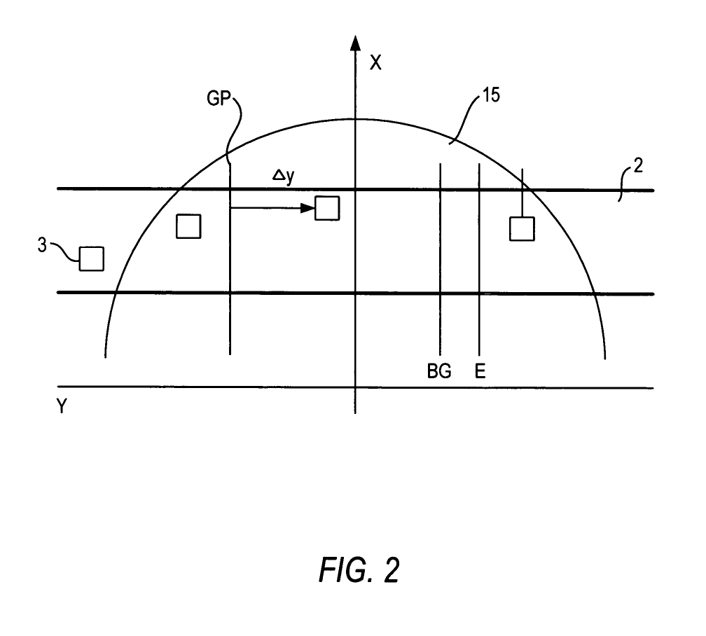

FIG. 2 shows the drive-on region 15 of the robot arm 1. The drive-on region includes the region, in which the gripping element 5 can move to any arbitrary position. The conveyor band 2 moves through the drive-on region 15, and the piece material 3 to be driven on is transported on it. The computation of the travel set in accordance with the first computation step is performed with respect to a base position GE. In other words, the first computation step is if performed as the drive-on position is located in the base position GP.

In the second computation step which is performed directly before the start of the drive-on movement on the respective piece material, the determined position of the actual piece material 3 to be driven on is taken into consideration however with respect to the base position GP. In other words, the drive-on position is displaced by a predetermined amount ΔY with respect to the base position GP in the movement direction of the conveyor band 2. In the second computation step starting from the travel set which was computed in the first computation step and by means of the differential value ΔY, a modified new travel set is calculated, which comes from an exact drive-on position, so that during performing of the drive-on movement the robot arm 1 and the corresponding piece material 3 reach the drive-on position at the same time. In the second computation step the end point is displaced by ΔY.

It is provided that the band speed is added to the path pieces of the travel set in a corresponding manner. In order to reach a most jerk-free accelerating and braking movement of the robot arm 1, it is possible to take into consideration the band speed of the conveyor band 2 sine-square in the path pieces of the previously calculated travel sets or add to the path pieces.

Actually, for each piece material 3 which is recognized by the detection system 11, a travel set is preliminarily provided and stored in a calculated favorable sequence in the storage element 9. When in the beginning of the second computation step it is recognized that the piece material is located in the drive-on region 15 so far, or in other words the differential value ΔY became so great that the piece material can not be reached with a drive-on movement in a guaranteed way, then the travel set is rejected and the next control data set which is stored as the next one in the storage element 9 is made ready. The decision whether the corresponding travel set is rejected takes place when the peace material is located behind a beginning limiting position BG. In other words, at the beginning of the second computation step for the corresponding travel set of the respective piece material 3, a respective piece material is already behind the beginning limiting position BG, so that the second computation step with the respective travel set is not performed.

When the second computation step provides an expected drive-on time, after which the piece material 3 to be gripped is located be behind an end position E, then the second computation step with respect to this travel set is also interrupted. In this way it is avoided that in the second computation step travel sets can be computed, with which the associated drive-on movement of the respective piece material no longer occur at a right time within the drive-on region.

For providing a further speed improvement during the drive-on movements of the robot arm 1 as well as to reach an increased jerk freedom, it can be provided that during the second computation step in the second computing means 10 path pieces of the actual travel sets are absorbed with a part or all path pieces of the next travel set, so that a rounded transition between the drive-on movement of the actual drive-on position to the drive-on movement of the next drive-on position is reached. This process is called overslipping, and it reduces accelerations which occur due to an abrupt direction change of the robot arm 1. The overslipping is performed in that, during the second computation step the path pieces are loaded with the path pieces of the subsequent travel sets, so that in particular the direction in which the gripping element 5 drives to the piece material 3 to be gripped is displaced in the direction, with which the next drive-on position is driven-on. Moreover, the overslipping can be performed so that the drive-on movement during which the drive-on position is not completely adapted to the speed of the piece material 3, but instead the taking or discharging the piece material 3 substantially is performed before, so that a time-expensive braking and repeated accelerations of the robot arm 1 are dispensed with. Thereby further time during working off of the travel set can be spared.

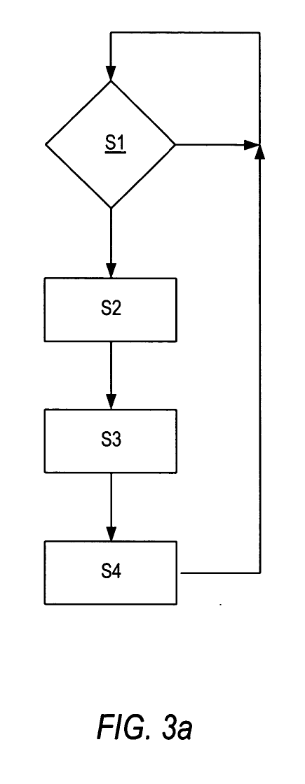

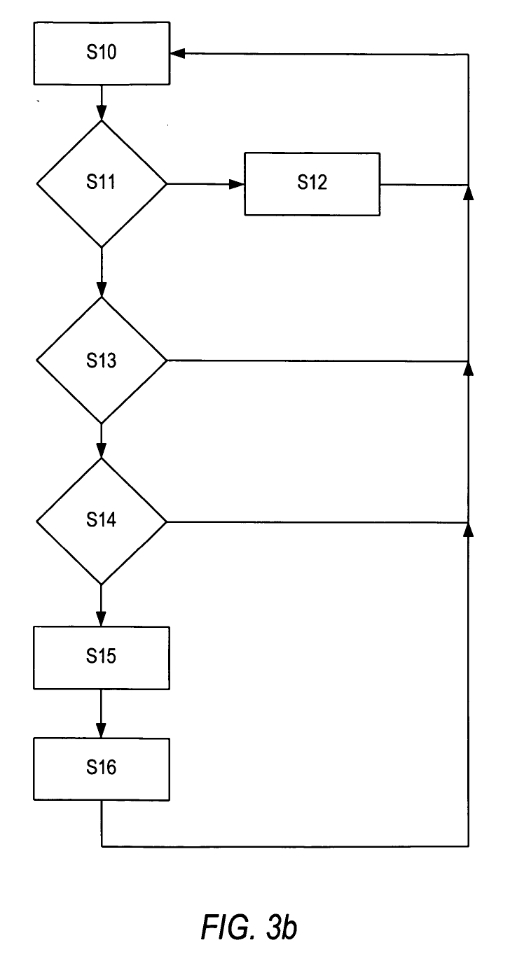

FIGS. 3a, 3b show a flow diagram for illustration of the inventive method in accordance with a preferable embodiment. The method deals with two planes. On the one hand as shown in FIG. 3a, it is checked whether on the conveyor band the piece material moves in the detection region of the detector system 11. This is tested in a step S1.

If it is determined that a piece material was moved in the detection region, then its position is determined in a step S2. For this purpose, both the x and also y positions is determined. The x position deals with the position of the piece material transversely to the movement direction of the conveyor band 2. The y direction corresponds to the movement direction of the conveyor band 2. When needed, also the orientation of the piece material 3 with respect to the conveyor band 2 is determined, and made ready as an information. Based on these coordinates, the position of the piece material 3 on the conveyor band 2 is exactly determined.

Subsequently the respective, recognized piece material 3 is provided with an identification number, and with respect to it one or several associated travel sets are calculated, wherein as y position of the respective piece material 3 a base position GP is taken. When necessary, furthermore in the first computation step S3 further control data sets are determined, which for example can provide the transmission from data to the monitoring unit 7. In some cases travel sets can be defined with respect to the taking or discharging of the respective piece material 3 by the gripping element 5.

After the control data sets are determined, they are stored in the storage unit 9. The storage unit 9 can be a FIFO storage, so that the new generated control data sets are joined with the already provided control data sets. The storing of the data is performed in a step S4. The determination of the control data sets is performed for each recognized control material 3 on the conveyor band 2, as long as the piece material 3 was recognized.

FIG. 3b shows a further method course for performing the inventive method, which is substantially performed at the same time as the preliminary computation method of FIG. 3a. The control data sets stored in the storage unit 9 are worked off now in a row. In a first step S10 the respective next control data set is read and in a step S11 it is determined whether it is a travel set or a further data set.

If it is a further data set, then in a step S12 it is substantially worked off. The further data set deals conventionally with the outputting the signals to the monitoring unit 7 and requires conventionally no further computing. After processing of the further data set the return is made to the step S10.

If it is a travel set, then in a step S13 it is first checked whether the piece material is located within the drive-on region 15 before the beginning limiting position BG. If it is located in the already behind the beginning limiting position BG, then the computation of this travel set is interrupted and the return is made to the step S10, and the processing of the next control data set begins.

If the piece material 3 is located before the beginning limiting position BG then first the time for driving on the respective piece material 3 is evaluated. When with the aid of the speed of the conveyor band 2 it is determined that the piece material after elapsing of this time is located behind an end position E, then in the step S14 it is decided to interrupt the computation step for the second computation step and to proceed with the next control data set in accordance with the step S10.

If the computation of the step S14 determines that the respective piece material 3 can be reached, then the preliminarily computed travel set is again computed with the aid of the actual position of the piece material. During the computation in the second computation step, from the result of the computation of the travel set in the first computation step it can be concluded that the computation in the second computation step requires less time than a new computation of the total travel set.

In particular during the second computation step S15 the next travel set stored in the storage element 9 is taken into consideration, so that an overslipping on the drive-on movement of the actual travel set for drive-on movement of the next travel set can be calculated. Since the respective next travel set is however a preliminarily calculated travel set which was computed from a fixed based position, during the computation of the overslipping it leads however to a minimal deviation. This can be as a rule negligible, since it is automatically compensated in a further course of the path pieces. Thereby the overslipping from one drive-on movement to a next drive-on movement can be substantially performed, in that for the next drive-on movement a travel set with respect to the base position GP as a drive-on position can be utilized.

After computing the travel set in the second computation step, the method movement is started, and the method path is speed-optimized with the aid of the PTP interpolation. After performing the method movement in the step S16, the return is made to the step S10 and the next control data set is worked off.

The idea of the present invention resides in computing the control data sets in advance, so that a computation must not be performed prior to each step related to the actual control data set, which otherwise substantially delay the travel movement of the robot arm 1 during the travel sets in time. For enabling exact controlling by the robot arm 1 of the piece material 3, when the control data which represent the travel sets, a further computation is required in a second computation step, which generates based on the first computation step generates a new travel set for exactly driving on the respective piece material 3. Thereby time can be saved, since on the one hand the control data sets which are not travel sets or in other words do not relate to the movement of the robot arm 1 can be preliminarily computed, and thereby the further computation in the second computation step can be accelerated, so that the stoppage times of the robot arm 1 are reduced.

Moreover, it is advantageous that for computation of the overslipping of one method movement to a next method movement of the next robot arm 1, the next travel set is already available. Thereby during the computation of the overslipping, the travel set which was determined in a first computation step is substantially sufficient for determination of a suitable overslipping movement. In a concrete embodiment it is to be understood that the first and second computing means, as well as the control element and/or the storage element can be provided in one or several microcontrollers. The inventive method can be stored as a program code in the microcontroller or the microcontroller can be set correspondingly. The microcontroller can be connected through a network (not shown) with the monitoring unit 7.

The times in which the preliminary computation of the control data sets takes place, are covered in correspondence with the loading of the microcontroller, so that the computation of the travel sets in the second computation step is performed substantially directly before the drive-on movement, while the preliminary computations can be performed during the times, in which the microcontroller has reached the computing capacity.

It will be understood that each of the elements described above, or two or more together, may also find a useful application in other types of constructions differing from the types described above.

While the invention has been illustrated and described as embodied in method of and apparatus for controlling driving of a gripping device to a movable piece material, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims:

1. A method of driving on a movable piece material over a drive-on path, comprising the steps of providing a drive-on position of the piece material inside a drive-on region; computing control data sets preliminarily in a first computation step; providing in the control data set a travel set which describes the drive-on path at the drive-on position; starting the first computation step for the travel set from a fixed drive-on position of the piece material; optimizing the travel set to the first fixed position of the piece material with respect to the drive-on speed; determining, directly before a start of a drive-on movement in accordance with the travel set, an actual drive-on position of the piece material; performing a second computation step which a corresponding actual travel set changed depending on the determined actual drive-on position of the piece material so that the drive-on path is changed in direction of the actual drive-on position; and performing a drive-on movement by working off of the travel set determined in the second computation step.

2. A method as defined in claim 1; and further comprising providing in the travel set an information about path pieces which describe the drive-on path at the drive-on position, wherein the path pieces are driven-on one after the other.

3. A method as defined in claim 2, wherein the control data set contains a first travel set for a first drive-on position and a second travel set for a second drive-on position, with which the first computation step can be computed in advance, wherein the second travel set includes the path pieces which reproduce a drive-on path to the second drive-on position, wherein prior to reaching an end position of the first travel set, at least a first of the path pieces of the second travel set is taken into consideration to guarantee a jerk-free transition of the drive-on movement of the first travel set to the second travel set.

4. A method as defined in claim 2, wherein during the second computation step the respective actually worked off path piece is changed depending on the detected actual position of the piece material, in that an end point of a path piece of the travel set is displaced by a path which depends on the actual drive-on position of the piece material.

5. A method as defined in claim 1, wherein with the second computation step the corresponding actual worked off path piece is changed depending on the movement speed of the piece material, in that the speed of the piece material is taken into consideration over the total travel set for providing a jerk-free acceleration and braking of the drive-on movement.

6. A method as defined in claim 5, wherein a speed of the piece material is taken into consideration sine-square over the whole travel set, so that in a drive-on region and in an end region a small speed of the piece material is taken into consideration in the second computation step.

7. A method as defined in claim 1, wherein several travel sets are preliminarily computed in the first computation step, wherein in the case of travel sets associated with several movable piece materials or one movable piece material are not converted into a drive-on movement when in the first computation step it is determined that the drive-on movement of the respective movable piece material has not reached within the drive-on region in a proper time.

8. A method as defined in claim 7, wherein the respective movable piece material is not reached the drive-in region in a proper time when the respective piece material is located in a movement direction behind a second position.

9. A control apparatus for controlling a drive-on movement of a drive-on control apparatus of a drive-on device for a movable piece material in which a drive-on position is driveable-on within a drive-on region in accordance with a travel set, the control apparatus comprising a first computing means for preliminarily computing control data sets in a first computation step, wherein the control data sets include at least one travel set computed based on a fixed drive-on position of the piece material in advance, and wherein the travel set describes a drive-on path, wherein the computed travel set is optimized for fixed position of the piece material with respect to a drive-on speed; a detector system for detecting an actual position of the piece material; a second computing means for performing directly before a start of the drive-on movement a further computation for the travel set in a second computation step, wherein the actual travel set is changed depending on the determined actual position of the piece material so that the drive-on path is changed in direction of the drive-on position; and a control element for controlling a drive-on movement by working off the travel set changed in the second computation step.

10. A control apparatus as defined in claim 9; and further comprising a storage element for storing a plurality of the travel sets in advance.

11. A control apparatus as defined in claim 9, wherein at least one of the first and second computing means is designed so that during transition from the first travel set to the second travel set path pieces of the first travel set are compensated with path pieces of the second travel set so that a substantially jerk-free transition is reached from the movement of the first travel set to the movement of the second travel set.
